(19) United States
(12) Patent Application Publication
(10) Pub. No.: US 2004/0035894 A1
(43) Pub. Date: Feb. 26, 2004

(54) Pouring apparatus for containers

(76) Inventors: Joseph F. Gobbini, Hudson, MA (US); Frank P. Damiano, East Boston, MA (US)

Correspondence Address: LITMAN LAW, OFFICES, LTD., P.O. BOX 15035, ARLINGTON, VA, 22215, US

(21) Appl. No.: 10/439,315

(22) Filed: May 16, 2003

Related U.S. Application Data
(60) Provisional application No. 60/378,094, filed on May 16, 2002.

(51) Int. Cl. B67D 3/00

(52) U.S. Cl. 222/479; 222/481.5

(57) ABSTRACT

A pouring apparatus for containers having an annular channel with an open top, a bottom wall, an inner wall and an outer wall. A plurality of tubes depend from the bottom wall and define fluid passageways in communication with the annular channel. The pouring apparatus is designed for insertion into a container, with the annular channel being disposed in the neck of the container and the tubes extending outward therefrom. Alternatively, the pouring apparatus may be built into the container as an integral part thereof during manufacture of the container.

### CROSS-REFERENCE TO RELATED APPLICATION

This application claims the benefit of U.S. Provisional Patent Application Serial No. 60/378,094, filed May 16, 2002.

### BACKGROUND OF THE INVENTION

1. Field of the Invention

The present invention relates to pouring devices, in particular to a pouring apparatus designed to produce a smooth, even pour from a container tilted at any orientation during pouring.

2. Description of Related Art

Containers for liquids generally have a single opening or mouth located on the uppermost part of the container. In order to pour the liquid contents, one must tilt the container at an angle so that the mouth is no longer the uppermost point of the container. When that is accomplished, gravity forces the liquid to exit the container, thereby causing air to enter the container and fill the space vacated by the liquid. An air space is thereby established in the highest part of the tilted container. Usually the airspace does not communicate directly with the mouth of the container. What happens is that air enters the mouth of container in large bubbles, which float up to the air space. This causes the liquid to be released irregularly from the container between these bubbles. The outflow of the liquid is strongly variable over time and a characteristic “glug, glug, glug,” sound is often produced. This irregular outflow continues until a large portion of the container is empty of liquid, and a permanent communication can be established between the mouth of the container and the airspace inside the container.

Several different methods have been developed to control irregular liquid outflow. One of the most simple is the “Wide Mouth” or “Big Mouth” bottle often used in conjunction with sports or soft drink bottles. With a wide mouth bottle, the mouth is so wide that communication between the air outside and the airspace inside the bottle is constantly maintained through the mouth itself. The drawbacks inherent with this method include the fact that the mouth must be nearly as wide as the bottle itself, and that the length of the bottleneck is also limited by the size of the mouth.

A second method of controlling irregular liquid outflow requires a container to have a second opening, ordinarily located away from the mouth of the container, and near where the airspace would develop inside the container when pouring. The second opening allows air in while the liquid escapes through the mouth. This two port method works quite well with containers with lower height to diameter ratios, such as gasoline containers, where both openings could be located on the top of the container. The method is not particularly suitable to containers with higher height to diameter ratios such as the familiar two liter soda bottle. This is due to the fact that the second opening would have to be positioned on the bottom of the bottle and would therefore be a leak hazard.

U.K. Pat. No. 2,320,017 granted to Tribble, outlines the use of a bottle, which solves the problem associated with the second opening being placed on the bottom of a bottle. The second opening has a valve, which permits air to enter the bottle, but does not permit liquid to escape. The present invention can be distinguished because it only has one external opening.

A third method of controlling irregular outflow is by shaping the container so that there is an alternative channel between the mouth and the bottom of the container; e.g., giving the container a hollow handle that extends down to the container bottom. A common example of this is a one-gallon milk container. This device, unlike the present invention, works only if the container is tilted in a particular direction when pouring; i.e., with the hollow handle up.

Several patents teach variations on the container-shaping theme. U.S. Pat. No. 4,838,464 issued to Briggs, outlines the use of a vented plastic bottle having a vent passage, extending along the interior of the bottle shoulder, from the top of the body to the bottom of the neck. The '464 invention requires that the bottle be poured from a single orientation.

U.S. Pat. No. 5,340,000 issued to Ring, outlines the use of a container having a novel neck arrangement, including a circular spout and a guiding neck portion, having a U-shaped ledge. During pouring, the ledge directs liquid from the container over the front edge of the spout, and permits air to enter the container, through the rear portion of the spout, to an air passageway connecting the rear of the spout to the inside of the container. The '000 patent can be distinguished from the present invention, because the present invention does not require a handle containing an air passage.

Although each of patents previously discussed are useful and novel, what is really needed is a device that can be used with a container, that eliminates irregular outflow of liquid from the container. Such a device should be used in combination with a container or be incorporated within a container. Such a device would certainly be well-received in the marketplace.

None of the above inventions and patents, taken either singly or in combination, is seen to describe the instant invention as claimed.

### SUMMARY OF THE INVENTION

The present invention is a pouring apparatus for containers that eliminate irregular liquid outflow from the mouth of the container. The pouring apparatus is designed to be inserted into a container having a single opening, for example a soda bottle, to be incorporated into such a container. The pouring apparatus has an annular channel. The annular channel is open at its top and has several perforations on its bottom surface. The annular channel is dimensioned to fit inside the neck of a container securely enough to prevent the passage of liquid between itself and the container. A plurality of tubes is attached to the perforations on the bottom of the annular channel.

Accordingly, it is a principal object of the invention to provide a pouring apparatus, which will prevent the irregular outflow of liquids from a container.

It is another object of the invention to prevent the spillage of liquid from a container, due to irregular liquid outflow.

Still another object of the invention is to provide a pouring apparatus for the prevention of irregular liquid outflow from such containers, which can be easily incorporated into a wide variety of containers.

It is a further object of the invention to provide a pouring apparatus, that will insure a regular outflow from a container at any pouring orientation.

It is an object of the invention to provide improved elements and arrangements thereof in a pouring apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a pouring apparatus for containers inserted into a container, according to the present invention.

FIG. 2 is a plan view of the pouring apparatus for containers.

FIG. 3 is an environmental side view of the pouring apparatus for containers.

Similar reference characters denote corresponding features consistently throughout the attached drawings.

### DETAILED DESCRIPTION OF THE PREFERRED EMBODIMENT

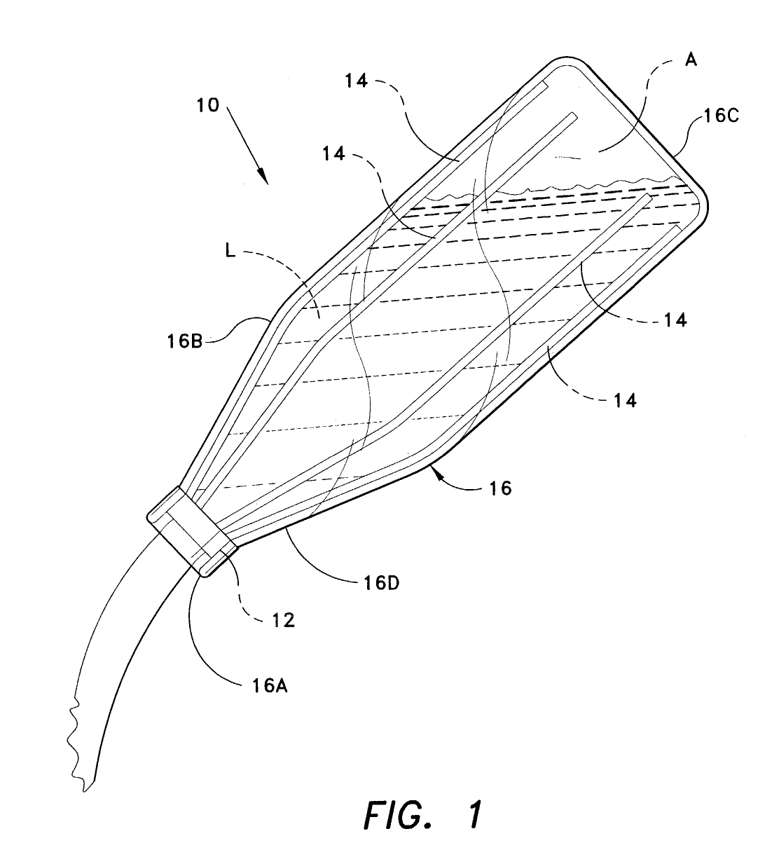

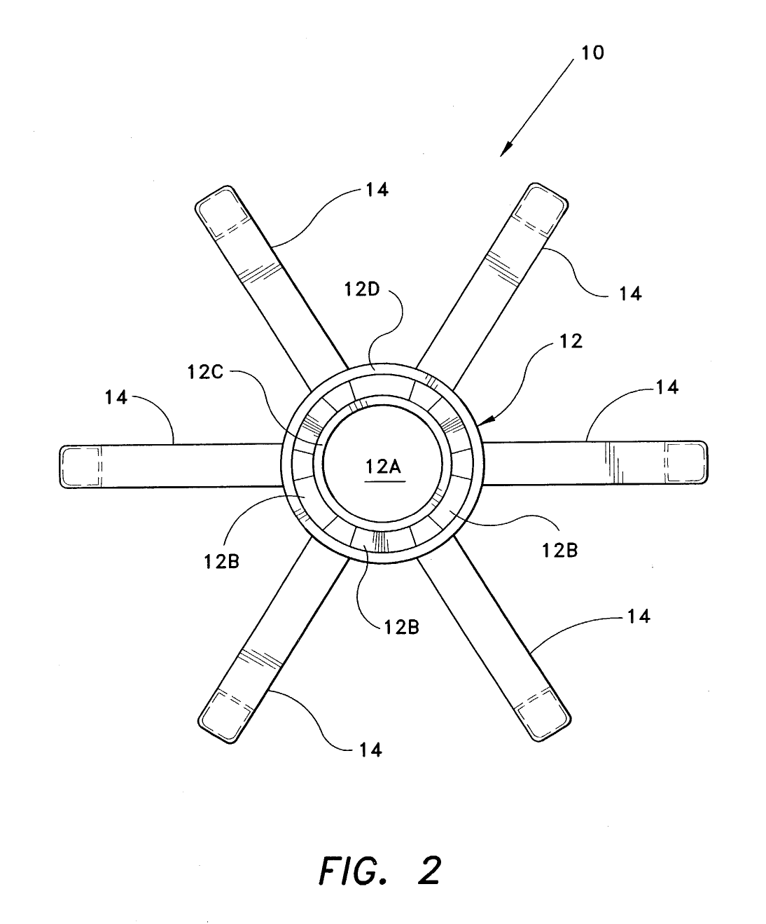

The present invention, as shown in FIG. 1 and FIG. 2, is a pouring apparatus 10, which can be used alone or in combination with a container 16. The pouring apparatus 10 has an annular channel 12. The annular channel 12 has an open top 12A, a bottom wall 12B, an inner wall 12C and an outer wall 12D, and is U-shaped in cross-section. A plurality of tubes 14 is attached to the bottom wall 12B of the annular channel 12 and extend outward therefrom. Each of the plurality of tubes 14 may be shaped and sized to conform to the walls of a particular container 16B and extend from the annular channel 12 to nearly the bottom of the container 16C.

When pouring liquid L from a container 16, an airspace A is formed. Ordinarily air traveling from the mouth of the container 16A to the airspace A, will interrupt the flow of liquid L from the mouth of the container 16A. The pouring apparatus 10 functions to allow air to travel to the airspace A, without interrupting the outflow of liquid L from the mouth of the container 16A. This is accomplished by allowing air to enter into the annular channel 12, through the open top of the annular channel 12A. From the annular channel 12, the air travels up some of the plurality of tubes 14 to the airspace A, when the container 16 is tilted.

FIG. 2 illustrates a top view of the pouring apparatus 10. In this embodiment, the pouring apparatus 10 has six tubes as part of the plurality of tubes 14, which are circular in cross-section. Each tube of the plurality of tubes 14 is attached to the bottom wall of the annular channel 12B, such that the annular channel 12 is in fluid connection with the inside of each tube of the plurality of tubes 14. The plurality of tubes 14 is preferably evenly spaced along the annular channel 12 and may vary in number, size and cross-section depending on the particular application.

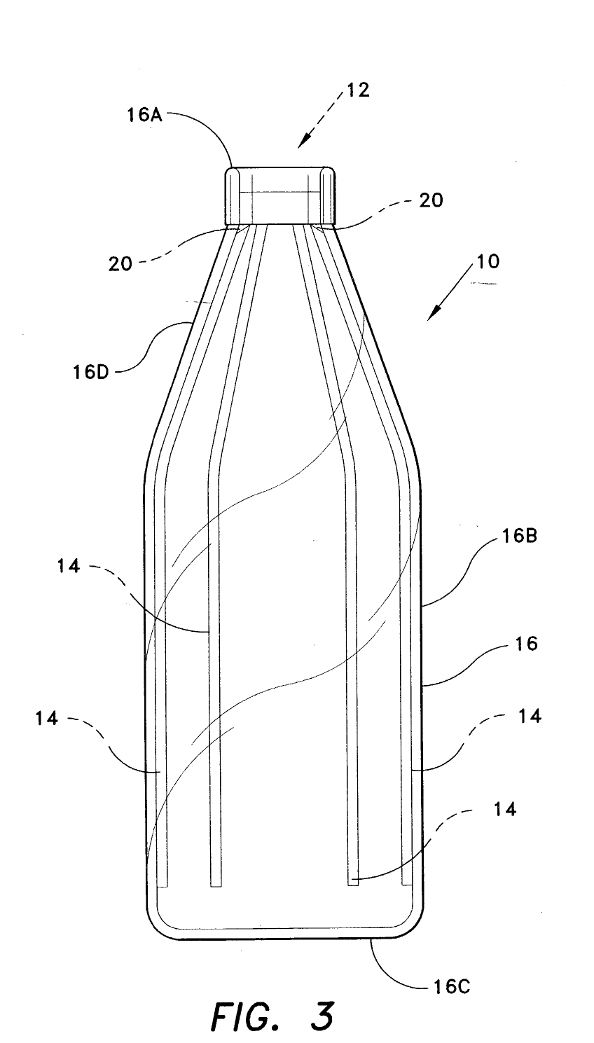

FIG. 3 illustrates a side view of the pouring apparatus 10. Each tube of the plurality of tubes 14 follows the contours of the walls of the container 16B and extend to a point near the bottom of the container 16C. The length and shape of each tube of the plurality of tubes 14 may be varied, depending on the shape and size of a particular container 16, with the pouring apparatus 10 capable of being shaped to fit almost any container 16. Several tabs 20 may be added to the neck of the container 16D, which protrude into the interior of the neck of the container 16D, to prevent the annular channel 12 from being inserted too far into the container 16. Alternatively, the neck of the container 16D may be provided with an internal flange or ridge (not shown), which serves as a stop for the same purpose.

It will be understood that the pouring apparatus 10 may be used separately or in combination with a container 16. The pouring apparatus 10 can be built into containers 16 such as plastic bottles, during manufacture of the bottles by blow-molding, injection molding, extrusion, or other manufacturing processes, or furnished as an individual after-market device for insertion into glass bottles and the like. In the latter case, the pouring apparatus 10 is preferably made from plastic, and may be made in various sizes. The annular channel 12 should be selected to fit snugly within the neck of the container 16D, yet having an internal diameter permitting the majority of liquid L to flow out of the container 16 through the open top 12A of the annular channel 12. The tubes of the plurality of tubes 14, may be straight, curved, or bent. In the latter case, the tubes of the plurality of tubes 14 are preferably sufficiently resilient, so that they may be compressed for insertion through the mouth of the container 16A and the neck of the container 16D, but expand to press against the walls of the container 16B, after passing through the neck of the container 16D.

In operation, when the container 16 is tilted to pour out liquid L and for a short period (approximately one second), air enters the uppermost tubes of the plurality of tubes 14, while liquid L slowly pours through the plurality of tubes 14 which are oriented lowermost. When air travels far enough through the plurality of tubes 14 that it reaches the airspace A in the bottom of the container 16C, to establish a continuous air passage, liquid L begins to drain continuously out of the open top 12A, defined by the annular channel 12.

It is to be understood that the present invention is not limited to the sole embodiment described above, but encompasses any and all embodiments within the scope of the following claims.

We claim:

1. A pouring apparatus, comprising;
an annular channel having an open top, a bottom wall, an inner wall and an outer wall disposed in a U-shaped configuration in cross-section; and
a plurality of tubes depending from the bottom wall of said annular channel, each of the tubes defining a fluid passageway communicating with said annular channel;
wherein the pouring apparatus is adapted for insertion into a container, said annular channel snugly fitting within a neck of the container and said plurality of tubes extending to a bottom of the container, whereby at least one of said tubes defines an air passageway, extending to an airspace in the bottom of the container, when the container is tilted to pour a liquid contained therein.

2. A pouring apparatus used in combination with a container, comprising;
the container having a bottom wall, at least one sidewall, and a neck;
an annular channel having an open top, a bottom wall, an inner wall and an outer wall, said channel being U-shaped in cross-section, said channel being defined within the neck of said bottle;
a plurality of tubes depending from the bottom surface of said channel, each said tube defining a fluid passageway in communication with said channel;
wherein each said tube extends from said annular channel along at least one sidewall of said container, terminating adjacent to the bottom wall of said container.
